(19) United States
(12) Patent Application Publication
(10) Pub. No.: US 2009/0090160 A1
(43) Pub. Date: Apr. 9, 2009

(54) Process for obscuring corrugations in a window well

(76) Inventor: Jeff R. Kemp, Ogden, UT (US)

Correspondence Address: Thompson E. Fehr, Goldenwest Corporate Center, Suite 300, 5025 Adams Avenue, Ogden, UT, 84403, US

(21) Appl. No.: 11/973,725

(22) Filed: Oct. 9, 2007

(51) Int. Cl. B21D 13/00; B05D 3/12; E04F 17/06

(52) U.S. Cl. 72/379.6; 72/370.19; 427/274; 52/107

(57) ABSTRACT

A process for obscuring corrugations in a window well employing painting on a metal surface a solid variegated pattern using perspective to create a three-dimensional effect on the face. Preferably, such painting occurs prior to the forming of the window well. In a preferred continuous process, a roll of metal is cut prior to the forming into a piece having such dimensions as to permit the piece to be formed into a single window well. The preferred metal is steel. And the solid variegated pattern using perspective to create a three-dimensional effect on the face can be a pattern of brick, stone, or the like, with granite being the preferred pattern.

### BACKGROUND OF THE INVENTION

1. Field of the Invention

This invention relates to a process for making corrugations used to strengthen a metal window well less visible and the resultant product.

2. Description of the Related Art

In lines 42 through 44 of column 3, U.S. Pat. No. 5,881,503 states, “ . . . Preferably, the interior surface [of the window well] is colored and textured to simulate a brick wall, granite or the like.

Similarly, U.S. Pat. No. 6,880,300 provides, in lines 40 through 53 of column 1, “Certain alterations to galvanized window wells are possible. Some homeowners may resort to painting the galvanized window wells to improve their appearance. However, the galvanized surface generally does not hold paint well, thereby frustrating a homeowner's desire for a low maintenance window well. A liner, made from a flexible synthetic material, is commercially available for placement interior to a galvanized window well to provide a more pleasing appearance from inside the house. However, when adding a liner, a homeowner pays for two structures to do the job an efficiently constructed window well can do. A stone facade or stucco-like material may also be applied to certain window wells to provide an improved cosmetic appearance to a viewer from inside a dwelling.” This patent, moreover, specifies, in line 66 of column 3 through line 2 of column 4, “ . . . In contrast to metal walls, and even to galvanized metal walls, the composite material forming the walls of the instant invention are [sic] rust-proof. . . . ”

And United States patent publication no. 20050252103 declares, in paragraph 0026, “The front surface 24 [of a window well formed from a composite material] may have a decorative and aesthetically pleasing design formed thereon. The decorative design may simulate a natural substance such as stone, wood or boulders. The decorative design may simulate other substances such as bricks or blocks, or any decorative look desired. The decorative design may also simulate natural landscape scenes such as trees, flowers, vine scenes or any other pleasing scene. The decorative design illustrated in FIG. 1 is meant to simulate the look and texture of stone blocks. The decorative design may be incorporated onto the front surface 24 during the production process. For example, a molding process may be used to form the decorative design in the front surface 24.”

Thus, neither the two patents nor the patent publication suggests painting to create an image of a “solid variegated surface,” which as used herein shall mean a surface imitating brick, stone (especially granite), or the like. Nor do these documents indicate using perspective to create a three-dimensional painting of the solid variegated surface. And, finally, there is no hint in the three documents that such a three-dimensional painting of the solid variegated surface would “obscure,” which as used herein shall mean tend to make less visible, corrugations used to strengthen a metal window well.

A process is, however, known for painting metal using perspective to create a three-dimensional painting of a solid variegated surface, especially granite.

### BRIEF SUMMARY OF THE INVENTION

In the process of the present intention a perspective painting of a solid variegated pattern using perspective to create a three-dimensional effect is placed upon the face a window well-either before or after the window well is formed.

Moreover, the process of forming and painting may either be continuous or discrete but is preferably continuous.

### BRIEF DESCRIPTION OF THE SEVERAL VIEWS OF THE DRAWING

FIG. 1 is a perspective view from slightly above the front and right of a window well having a painting of a solid variegated pattern using perspective to create a three-dimensional effect on the face of a window well.

FIG. 2 is a plan view from the front of a window well having a painting of a solid variegated pattern using perspective to create a three-dimensional effect on the face of a window well.

FIG. 3 is a plan view from the rear of a window well having a painting of a solid variegated pattern using perspective to create a three-dimensional effect on the face of a window well.

FIG. 4 is a plan view from a side of a window well having a painting of a solid variegated pattern using perspective to create a three-dimensional effect on the face of a window well.

FIG. 5 is a plan view from the top of a window well having a painting of a solid variegated pattern using perspective to create a three-dimensional effect on the face of a window well.

### DETAILED DESCRIPTION OF THE INVENTION

Many traditional window wells 1 are made of metal; have a top 2, bottom 3, face 4, and back 5; are formed, as viewed either from the top 2 or the bottom 3, into a generally U-shaped configuration with corrugations 6 to strengthen the resultant window well 1.

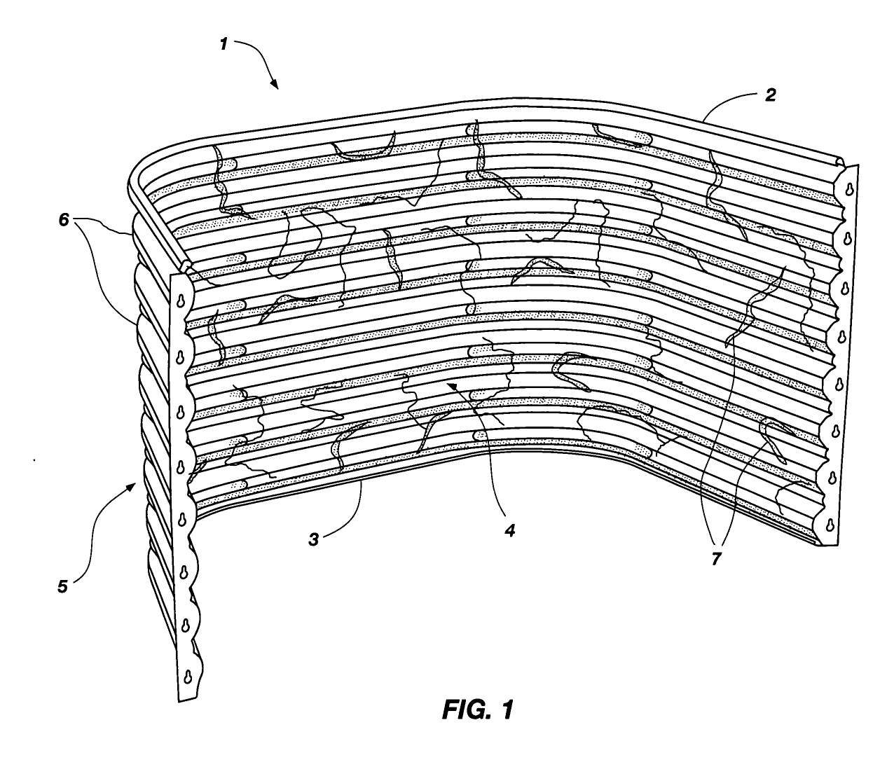

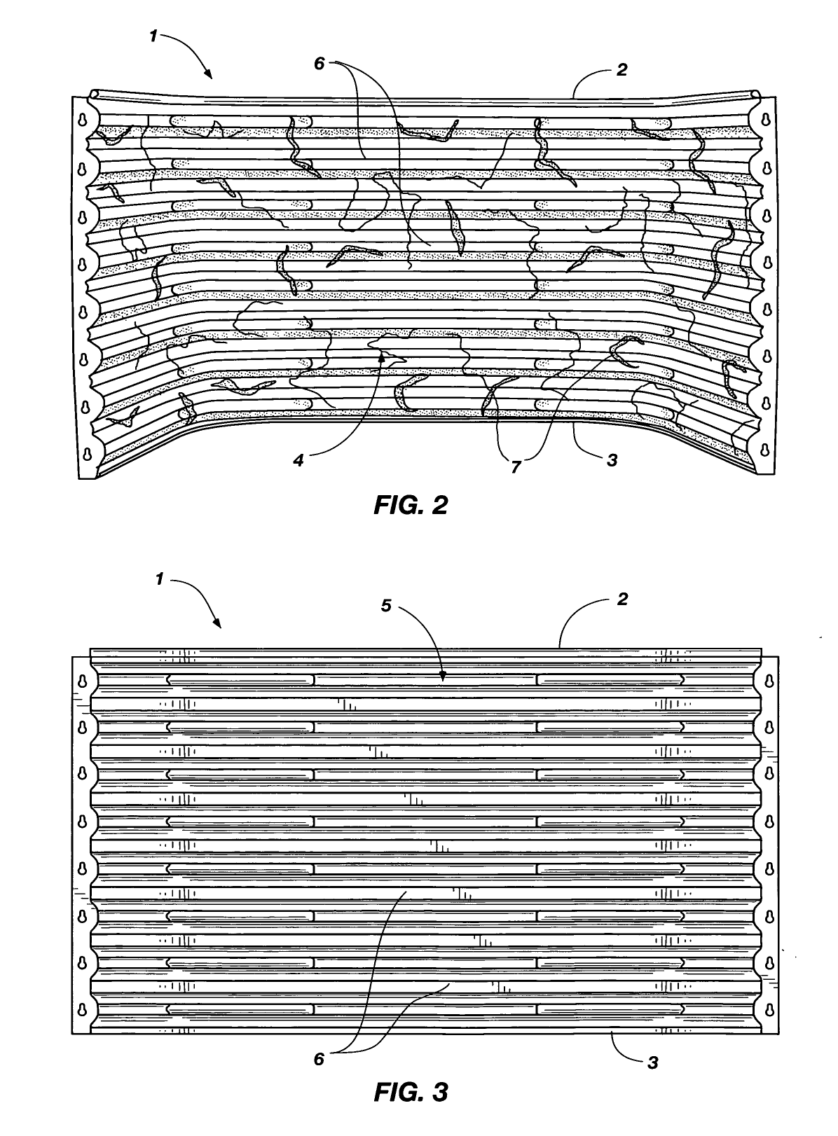

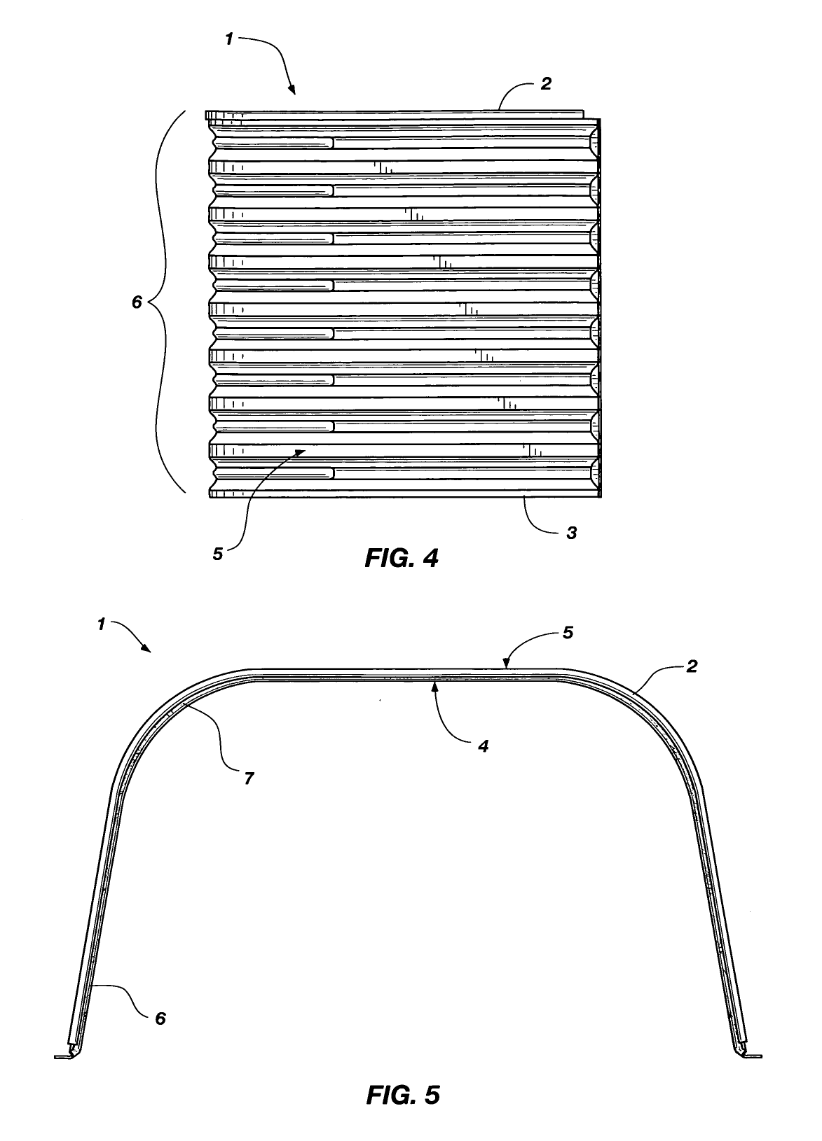

An important feature of the present process and resultant product is the painting of a solid variegated pattern using perspective to create a three-dimensional effect 7 onto the face 4 of the window well 1 as can be seen in FIGS. 1 through 5.

Preferably, the solid variegated pattern using perspective to create a three-dimensional effect 7 is first painted onto a metal surface. The metal is preferably then rolled in order to be formed with a continuous process. Individual sheets of metal can, however, be painted for subsequent forming in a discrete process.

The painting can be done through any technique that is well known in the art but is preferably done through a commercially available technique by Pre-coat Metals of St. Louis, Mo.

Preferably, after the painting the metal is formed into window wells I having corrugations. In a continuous process, which is preferred, both cutting and forming are involved. Before forming a roll of metal is cut into a piece having dimensions that permit the piece to be formed into a single window well.

The forming (and cutting) can be done with any technique that is well known in the art but is preferably done with a roll former such as that which is commercially available from ASC of Spokane, Wash., or with a break press.

Optionally, the painting can be done after the forming.

The metal is preferably steel, and the solid variegated surface is preferably stone and, even more preferably, granite.

Although it would have been logical to believe that the corrugations would cause the solid variegated surface not to resemble the pattern it is intended to imitate, the inventor has learned that the solid variegated surface actually tends to hide, i.e., obscure the corrugations.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A process for obscuring corrugations in a window well, which comprises:
painting a solid variegated pattern using perspective to create a three-dimensional effect on a sheet of metal; and
then forming the sheet of metal into a window well having a face and corrugations with the face containing the solid variegated pattern using perspective to create a three-dimensional effect.

2. The process for obscuring corrugations in a window well as recited in claim 1, wherein:
the sheet of metal is a roll; and
further comprising:
after painting, cutting the roll into a desired size for a window well.

3. The process for obscuring corrugations in a window well as recited in claim 2, wherein:
the metal is steel.

4. The process for obscuring corrugations in a window well as recited in claim 2, wherein:
the solid variegated pattern using perspective to create a three-dimensional effect is a brick pattern.

5. The process for obscuring corrugations in a window well as recited in claim 2, wherein:
the solid variegated pattern using perspective to create a three-dimensional effect is a stone pattern.

6. The process for obscuring corrugations in a window well as recited in claim 1, wherein:
the sheet of metal has dimensions permitting the sheet to be formed into a single window well.

7. The process for obscuring corrugations in a window well as recited in claim 6, wherein:
the metal is steel.

8. The process for obscuring corrugations in a window well as recited in claim 6, wherein:
the solid variegated pattern using perspective to create a three-dimensional effect is a brick pattern.

9. The process for obscuring corrugations in a window well as recited in claim 6, wherein:
the solid variegated pattern using perspective to create a three-dimensional effect is a stone pattern.

10. A process for obscuring corrugations in a window well, which comprises:
painting a solid variegated pattern using perspective to create a three-dimensional effect on a roll of steel wherein the solid variegated pattern using perspective to create a three-dimensional effect is a granite pattern; and
then cutting and forming the steel into a window well having a face and corrugations with the face containing the solid variegated pattern using perspective to create a three-dimensional effect.

11. A process for obscuring corrugations in a window well, which comprises:
painting a solid variegated pattern using perspective to create a three-dimensional effect on a roll of steel wherein the solid variegated pattern using perspective to create a three-dimensional effect is a brick pattern; and
then cutting and forming the steel into a window well having a face and corrugations with the face containing the solid variegated pattern using perspective to create a three-dimensional effect.

12. A process for obscuring corrugations in a window well, which comprises:
forming a sheet of metal into a window well having a face and corrugations; and
then painting on the face a solid variegated pattern using perspective to create a three-dimensional effect.

13. The process for obscuring corrugations in a window well as recited in claim 12, wherein:
the sheet of metal is a roll; and
further comprising:
before forming, cutting the roll to create a piece having dimensions that permit the piece to be formed into a single window well.

14. The process for obscuring corrugations in a window well as recited in claim 13, wherein:
the metal is steel.

15. The process for obscuring corrugations in a window well as recited in claim 13, wherein:
the solid variegated pattern using perspective to create a three-dimensional effect is a brick pattern.

16. The process for obscuring corrugations in a window well as recited in claim 13, wherein:
the solid variegated pattern using perspective to create a three-dimensional effect is a stone pattern.

17. The process for obscuring corrugations in a window well as recited in claim 12, wherein:
the sheet of metal has dimensions permitting the sheet to be formed into a single window well.

18. The process for obscuring corrugations in a window well as recited in claim 17, wherein:
the metal is steel.

19. The process for obscuring corrugations in a window well as recited in claim 17, wherein:
the solid variegated pattern using perspective to create a three-dimensional effect is a brick pattern.

20. The process for obscuring corrugations in a window well as recited in claim 17, wherein:
the solid variegated pattern using perspective to create a three-dimensional effect is a stone pattern.

21. An improved window well of the type having a top, a bottom, a face, and a back and being formed into a substantially U-shaped configuration with corrugations, wherein the improvement comprises:
a granite solid variegated pattern using perspective to create a three-dimensional effect on the face of the window well.
